(19) United States
(12) Patent Application Publication
(10) Pub. No.: US 2002/0184485 A1
(43) Pub. Date: Dec. 5, 2002

(54) Method for electronic communication providing self-encrypting and self-verification capabilities

(76) Inventors: James F. Dray JR., Myersville, MD (US); Mark E. McLarnon, Baltimore, MD (US)

Correspondence Address: Michael de Angeli, Suite 330, 1901 Research Blvd., Rockville, MD, 20850, US

(21) Appl. No.: 09/735,804

(22) Filed: Dec. 14, 2000

Related U.S. Application Data
(60) Provisional application No. 60/172,835, filed on Dec. 20, 1999.
(60) Provisional application No. 60/184,801, filed on Feb. 24, 2000.

(51) Int. Cl. H04L 9/00

(52) U.S. Cl. 713/150

(57) ABSTRACT

Electronic signatures and the possibility of encrypting documents are important to secure electronic commerce and communication. This invention provides methods for creating Self-Signing Document Objects (SSDOs) that contain an embedded signature processing program to generate and verify unforgeable electronic signatures, and Self-Encrypting Document Objects (SEDOs) that include within them a cipher management program that includes the decrypting algorithm or a link thereto. The signature verification and decryption processes of the invention use only the standard capabilities of document representation languages (e.g. HTML) that support dynamic content. Accordingly, the SSDOs and SEDOs can be processed by any document representation language that supports dynamic content, for example, by any functional Web browser.

### CROSS-REFERENCE TO RELATED APPLICATIONS

This application claims priority from two Provisional Patent Applications, Ser. Nos. 60/172,835, filed Dec. 20, 1999 and 60/184,801, filed Feb. 24, 2000.

### FIELD OF THE INVENTION

This application addresses two related aspects of secure electronic communication: encryption of messages, such that only a known recipient in possession of a secret key can read the message, and verification of messages, such that the text and origin of a message can be verified. According to the invention, both capabilities are effectively “built into” messages that can be transmitted over the Internet and decrypted or verified by any computer implementing a document representation language that supports dynamic content, e.g., any standard Web browser, such that elaborate procedures to ensure that the transmitting and receiving computers have the same software, etc., as required by the prior art, are no longer necessary.

### BACKGROUND OF THE INVENTION

a. Document and Signature Verification

Secure electronic commerce requires an electronic equivalent of the handwritten signatures traditionally used to authenticate hardcopy documents, that is, to verify the contents and origin of the document. Known cryptographic technology makes it possible for a signer to generate an electronic signature on electronic data that is essentially unforgeable, using a secret or private key known only to the signer. See Federal Information Processing Standards Publication 186, “Digital Signature Standard (DSS)”, The National Institute of Standards and Technology, May 1994. The signature can subsequently be verified by anyone who has access to the signed data, appropriate keying material (that is, a “public key” that can be used to verify that the message originated from the possessor of the private key), and the correct signature verification algorithm. Electronic signatures therefore provide verification that electronic data originated from a particular signer, and that the data has not been altered after it was signed. This mechanism is a cornerstone of electronic document processing, since many electronic documents are meaningless unless their origin and structural integrity can be verified.

In fact, the U.S. Patent and Trademark Office (“PTO”) has recently announced an Electronic Filing System (“EFS”) for electronic filing of patent applications and other documents. It will be apparent that in order for this scheme to provide reliable transmission of patent applications and other documents the contents of which must be verifiable decades later (so as to serve as reliable evidence in questions of priority of invention and the like), the entire document must be received and stored in a manner that makes the accuracy of its contents absolutely unquestionable. The PTO's EFS scheme appears to conform to the model described above for electronic document signature and verification, in that it requires downloading of particular software, so that both the sender and the PTO as receipient have the same software and can cooperate to verify the accuracy of the document. Similarly, the PTO process requires the user to apply for a “certificate” whereby users will obtain a pair of of public and private keys. The significance of this fact, and the advantages and disadvantages of such schemes in general, will be discussed in detail below.

Electronic documents are often encoded in web-compatible formats such as HyperText Markup Language (HTML), as defined in REC-HTML40-1998024, “HTML 4.0 Specification”, W3C Recommendation, April 1998. These documents are translated and presented in human-readable form by “Web browsers”, e.g., Netscape, Microsoft Internet Explorer and the like, and other document-oriented applications. Such Web browsers are referred to herein as examples of a class of document representation languages that support dynamic content, that is, which can include executable program code (e.g., “Java applets” or universal resource locators (“URLs”)) as well as text per se.

Despite the fact that electronic signature processing, that is, in order to allow verifiable transmission of legally binding documents, is fundamental to secure electronic commerce, current Web browsers do not have explicit support for the generation and verification of signatures on electronic documents, creating a very significant potential security problem, in that the electronic documents relied on for e-commerce are subject to corruption. That is, although Web browsers provide a universality of communication between incompatible computer systems, which is essential to successful e-commerce, current Web browsers do not support universality of document and signature verification, which is self-evidently desirable in a system relying on the creation of countless enforceable contracts.

By comparison, known systems for document and signature verification rely on document processing applications that use differing techniques for signature processing, creating a myriad of incompatible document signature formats and processes. There are a number of proposed schemes for signing electronic documents, but these schemes have serious drawbacks in that they require extensions to a document representation language specification (see Note, XFDL-19980902, “Extensible Forms Description Language (XFDL)4.0”, W3C Note, September 1998), or manipulation of the document object by a program routine that is part of the host document processing application (see Maruyama et al, XML and Java, Addison-Wesley (1999)). More specifically, before any of the existing signature verification schemes can be made workable, both the sending and the receiving computers must have the same document processing application program installed and similarly configured, so that the overall process can be effectively managed. “Management” in this context includes ensuring effective agreement on such issues as document formatting, reduction of a document to its canonical representation (i.e., removing surplusage from forms and the like, so that only critical information needs to be transmitted, and conformity to a convention for a common format of the data structure containing the elements of the data structure), reduction of the message to a suitably-formatted bit stream, and agreement on the maintenance and mechanism of obtaining key information. This process is awkward in practice and utterly unworkable for the vast majority of e-commerce, which as noted relies on interoperability of a wide variety of different computers and operating systems. Again, the PTO's EFS scheme provides an example, in that the PTO documentation makes it quite clear that the process requires one to download software created and maintained by the PTO.

b. Encryption of Messages

A similar problem arises with respect to confidentiality, which is vital to many electronic transactions. During storage and transmission, it is often desirable to protect the contents of electronic documents so that only the document's originator and intended recipient(s) can view their contents. Cryptographic techniques are often used to ensure the confidentiality of electronic data. The creator of an electronic document can encrypt (or “encipher”) the “plaintext” content of the document, transforming it into illegible “ciphertext”. Only parties who possess the correct cryptographic “key” can decrypt (or “decipher”) the document, transforming the ciphertext back into plaintext.

Traditional methods for encrypting and decrypting require a high degree of coordination between the application programs used to process the electronic documents, because each application needs to implement precisely the same algorithms for encryption and decryption of documents. As above, the requirement of coordination precludes use of traditional cryptographic techniques to protect the confidentiality of documents transmitted via the Internet, where by design the communicating computers are not coordinated in advance.

More specifically, the traditional cryptographic model for encryption, transmission and decryption of a message is shown by FIG. 1. The sender, Alice, employs a secret key to operate an encryption algorithm, e.g., the Data Encryption Standard (DES) defined in FIPS Pub. 46-2 (1993), to turn her plaintext message into ciphertext, at 10. She then transmits the ciphertext to the recipient, Bob, as indicated at 12, and separately transmits the secret key to Bob, as indicated at 14. At 16, Bob uses the key and the corresponding decryption algorithm to decrypt the ciphertext.

The advantage of this system is that because the encrypting and decrypting algorithms need not themselves be secret, they can be widely published, making it relatively easy to ensure that the transmitting and receiving computers (i.e., the machines implementing the encrypting and decrypting algorithms, respectively) can cooperate to effectuate communication. That is, this fact allows standard commercially-available personal computers to be used to implement the encryption and decryption algorithms, as opposed to systems wherein dedicated coding and decoding machines were required. In theory this would allow secure communication over the Internet, which would be a significant advantage to many organizations that would otherwise have to construct their own private communication facilities for secure communication. However, the degree of difficulty involved in such programming, in particular the necessity of ensuring that both machines have exactly the same version of the algorithm installed, is still far in excess of that to be expected of the typical user, such that such encrypted communication is still impractical for consumers, small businesses and the like. Accordingly, encrypted communication according to the classical model is relatively unworkable in the modern context of convenient communication using the Internet, again since the premise thereof is that various differing types of computer can communicate with one another without coordination efforts (such as installation of identical cryptographic algorithms) being undertaken in advance.

FIG. 2 shows one implementation of the classical model of encrypted communication for use over the Internet and further illustrates the problem. For example, an application program at the sender's location, e.g., Microsoft Outlook Express, can be used to encrypt a document using a known algorithm, such as the DES algorithm mentioned above, and a secret key. The ciphertext can then be e-mailed to the recipient, and the key separately communicated; if the recipient has the same version of the same algorithm, and the same application program, it should be possible to decrypt the message.

The above classical model of encrypted communication is referred to as a symmetrical, secret key system. As mentioned above, a somewhat similar problem is posed by the necessity of verification of the contents of documents, including their signatures; this is usually referred to, and is herein, as the signature-verification problem. As compared to the encryption problem, where the contents of the document must themselves be kept secret, the signature verification problem presumes that the message can be public (although it can be combined with other means to encrypt the document, as is apparently the case with the PTO's EFS scheme), and is addressed to methods of ensuring that the contents of the message can be verified.

FIG. 3 shows a block diagram of the classical model used for signature verification. As compared to the encryption model discussed above, referred to as a symmetrical, secret-key system, signature verification according to this model is an asymmetrical, public-key (or sometimes referred to as a “private/public key”) system. As shown, at 30 Alice supplies her plaintext document and a private key to a computer 32 implementing a known algorithm, e.g., the Digital Signature Standard (DSS) described in FIPS Pub. 186 (1994). The “encoded” plaintext document, i.e., the document having had a “signature” generated using Alice's unique private key appended thereto, is transmitted at 34, and received by Bob's computer at 36. Bob's computer then consults a certified list 38 (such as that maintained by the PTO's Certificate Authority) in which Alice's name is associated with a public key, and attempts to verify the message, using an algorithm designed such that Alice's public key can be used to verify her signature (and thus the contents of the whole document), but not to discover her private key. If the result of the verification process indicates that the message was indeed sent by Alice, Bob is so informed at 40.

As in the case of the encryption/decryption process discussed above, signature verification as described is workable, but only if both parties' computers understand the encoding and decoding processes identically; this is a significant requirement, sufficiently onerous to preclude general use of signature verification for e-commerce over the Internet, despite the obvious desirability of verification of transactions.

### OBJECTS OF THE INVENTION

It would be desirable to provide a method whereby the advantages of encrypted communication and signature verification could be provided for general and convenient use over the Internet, and such is accordingly an object of the invention.

More specifically, it is an object of the invention to provide a method whereby an encrypted message or one encoded for verification can carry within itself all information needed to specify the algorithm needed for its decryption or verification, respectively, so as to eliminate the requirement of the prior art that the sending and receiving computers be running the same operating system, have the same algorithms preinstalled and working identically, and so on.

It is still a further object of the invention to provide a method for encrypting a message or encoding a message for verification including all algorithmic information needed for its decryption or verification, respectively, so as to allow general use of encryption and verification technology across the Internet, since any recipient (supplied with the sender's private key, in the case of an encrypted message) would then have, or have access to, all information needed to decrypt or verify the message.

### SUMMARY OF THE INVENTION

The invention provides methods for communicating documents including self-encryption and self-verification capabilities. In both cases, the facility provided by document representation languages supporting dynamic content, that is, for including executable program instructions within a document, such as the so-called hypertext markup language (HTML) implemented by conventional Web browsers, is exploited. For example, when a document is encrypted according to the invention using the DES algorithm, the algorithm necessary to correspondingly decrypt it (or a link allowing retrieval of the proper algorithm from a Web site, which is functionally the same thing) is embedded in the document itself. Accordingly, if the recipient's computer is equipped with a conventional Web browser (i.e., is able to run HTML programs, as needed in general to use the Internet) it will be capable of accessing, if necessary, and running the correct decryption algorithm; therefore, if the recipient has been separately supplied with the sender's private key, he or she will be able to decrypt the message, without any necessity of ensuring that both computers have the same operating system or the like.

Stated more generally, the invention comprises a unique method for creating electronic documents that are self-encrypting and self-decrypting, by embedding a program within “document objects” (this term being used generally to refer to documents including executable instructions) to manage the encryption and decryption processes. This method eliminates the need for proprietary plug-ins, postprocessing of documents outside the context of the document rendering application, or extensions to the standards and specifications for document representation languages. Since all Self-Encrypting Document Objects according to the invention (“SEDOs”) share a common technology for managing the encryption and decryption processes, the method of the invention is relatively independent of the applications used to view and manipulate SEDOS, that is, the method of the invention is independent, for example, of the specific Web browsers used by the sender and recipient. The SEDO method is therefore a vast improvement over traditional document encryption systems, because SEDO objects can be processed by any application program that understands the standard document representation language of an SEDO. In the preferred embodiment, any document representation language that supports dynamic content, such as any Web browser, can be used to encrypt and decrypt documents according to the invention.

Similarly, document (or signature) verification according to the invention involves encoding a document using a sender's private key and a particular algorithm. Either the algorithm or a link to a Web page including the algorithm is embedded in the message when sent, as in the case of executable code embedded in an ordinary Web page. When the message is received, the recipient is thus in possession of the required verification algorithm, and need merely locate the putative sender's public key to verify the message.

More specifically, the invention involves a unique method for creating electronic documents (referred to herein as “Self-Signing Document Objects” or “SSDOs”) that are self-signing and self-verifying, by embedding a signature processing program within document objects. As above, this method eliminates the need for proprietary plug-ins, postprocessing of documents outside the context of the document rendering application, or extensions to the standards and specifications for document representation languages. Since all self-signing document objects according to the invention (“SSDOs”) share a common signature processing technology, this method is independent of the application programs used to view and manipulate SSDOs. The SSDO method is therefore a vast improvement over traditional document signature systems, because SSDO objects can be processed by any application that understands the standard document representation language of an SSDO. In the preferred embodiment, any document representation language that supports dynamic content, such as any Web browser, can be used to process the SSDOs of the invention.

### BRIEF DESCRIPTION OF THE DRAWINGS

The invention will be better understood if reference is made to the accompanying drawings, in which:

FIG. 1 shows schematically the classical model of encrypted communication;

FIG. 2 shows schematically the implementation of the classical model of encrypted communication in an Internet implementation;

FIG. 3 shows the classical model of signature verification;

FIG. 4 is a diagram illustrating the life cycle of Self-Signing Document Objects (SSDOs) according to the invention;

FIG. 5 is a diagram summarizing the architecture of the SS-DHTML prototype code; and

FIG. 6 is a diagram similar to FIG. 4 illustrating the life cycle of Self-Encrypting Document Objects (“SEDOs”) according to the invention.

### DETAILED DESCRIPTION OF THE PREFERRED EMBODIMENTS

In the following, a detailed explanation is given of the operation of the method of the invention to provide a message encoded for verification, i.e., an SSDO according to the invention, and its corresponding verification. Operable code is also provided, ensuring the ability of those of skill in the art to understand and practice the invention. Following this there is a somewhat less extensive discussion of the extension of these methods to self-encrypting and decrypting document objects; implementation thereof is within the skill of the art given the disclosure provided by this application.

1. The Self-Signing Document Object Model

Many document representation languages allow developers to include executable content (programs) within electronic documents. A prime example is Dynamic HTML (see REC-DOM-Level-1-19981001, “Document Object Model (DOM) Level 1 Specification”, W3C Recommendation, October 1998), which supports scripting languages such as JavaScript and Java “applets”. The invention can also be employed with alternative languages per se, such as that known as “XML”, or with “macros” provided within other application programs, such as Microsoft Word. The present invention includes a method that takes advantage of this capability to create Self-Signing Document Objects (SSDOs). These document objects are called “self-signing” because they have the ability to calculate and verify electronic signatures upon themselves, when required to do so.

Cryptographic signatures can be generated in a number of different ways. Asymmetric (public) key signature schemes are the most common, using a private key for generating signatures, and a mathematically-related public key for verifying signatures (see NIST Special Publication 800-2, “Public Key Cryptography”, The National Institute of Standards and Technology, April 1991). The examples in this application are based on public key cryptography, but the SSDO method of the invention is general in that it can use any cryptographic signature mechanism that creates unique and computationally unforgeable electronic signatures.

The SSDOs generated, transmitted and decoded according to the invention contain (or provide a link to) an embedded signature processing program for generating and verifying electronic signatures. Since the electronic signature operations are embedded in document objects, these operations are independent of the applications that process document objects. Therefore, each time a document object is instantiated, a copy of the signature processing program becomes part of that object. This allows developers to create application-independent SSDOs by using standard templates that include the signature processing programs, rather than repeatedly implementing standalone program routines for each document processing application.

According to the invention, a signature processing program is embedded in an SSDO; this manages generation and verification of electronic signatures, and thus provides an important element of the self-signing document. The signature processing program is activated by certain events that occur within the context of the host document object, such as a user “clicking” on a “button” that is an element of the document, that is, selecting the signature processing option from an appropriate screen. A signature program may be physically embedded within the host document, or may be an external program file that is executed through a link within the document.

In the preferred embodiment of the invention discussed in detail herein, the specific functions of the embedded signature processing program are as follows:

At the transmitting computer:

Collecting the elements of the host document into a data structure that represents the canonical form of the document at the time of signature, that is, arranging the elements of the document object in a defined common format, in order that the Cipher Management Program (discussed below) will be able reliably to decompose the document into a consistent data structure for processing;

Reducing the canonical data structure into a bit sequence suitable for processing by an electronic signature algorithm;

Obtaining cryptographic key material in a secure manner, or passing the data to be signed/verified to a secure cryptographic module;

Passing the bit sequence and key material to an electronic signature algorithm, which then provides a suitably encoded message, including either the algorithm itself or a link to to a site from which it can be downloaded; and

Transmitting the encoded message; and

At the receiving computer:

Receiving the encoded message;

Obtaining the sender's public key;

Employing the signature algorithm embedded in the encoded message, or downloaded from a Web site the address of which (i.e., the URL of which) is embedded in the encoded message, to attempt to verify the encoded message;

Retrieving the output of the signature algorithm;

Notifying human users of the results of signature verification processes; and, if the verification attempt was successful,

Passing the signature and signed data to host applications.

2. Life Cycle of Self-Signing Document Objects

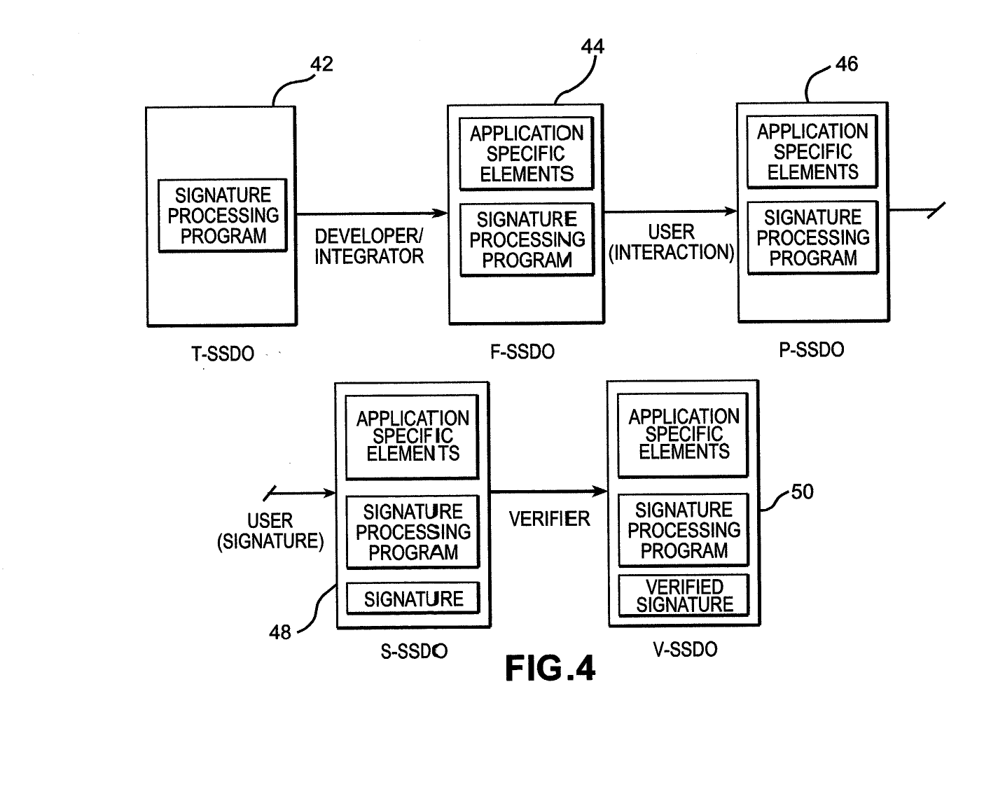

This section of this application describes the generic life cycle of SSDOs, that is, functionally illustrates the steps whereby a message is encoded so as to be suitable for verification, transmitted, and verified, independent of the document representation language used to encode the host document. As noted above, the only language-specific requirement for implementing SSDOs is that the document representation language must support embedded dynamic elements, e.g., the language must have the ability to execute programs based on events that occur within the context of the document object. The SSDO lifecycle is illustrated by FIG. 4.

2.1 SSDO Fabrication

According to the invention, SSDOs start out as Template SSDOs (T-SSDOs), shown schematically at 42 in FIG. 4, that contain an embedded electronic signature processing program. These are “templates” in the sense that they include the key elements, in this case, the embedded electronic signature processing program, and accept application-specific additional elements. For example, if the application is purchase-order processing, the additional elements to be added will include shipping and billing addresses, spaces for entry of line items to be purchased, and so on. A complete example of use of the invention in connection with purchase order processing is provided below. The template is a conventional document object in that mechanisms for allowing forms to be thus generated and specialized are well-known.

The embedded electronic signature processing program is generic in the sense that it will function with any application program that understands the standard document representation language of the T-SSDO, e.g., with any functional Web browser, and therefore does not need to be modified for different applications. The signature processing program provided as part of the template that becomes a T-SSDO supports the functions listed above. Developers customize T-SSDOs by adding application-specific elements to these T-SSDOs, such as labels and text input fields. After a T-SSDO has been customized by adding application-specific elements, it is referred to as a Fabricated SSDO (F-SSDO), as illustrated at 44. An F-SSDO is always specific to a particular application set since it contains application-specific elements in addition to the application-independent signature processing program.

2.2 User Processing

F-SSDOs are then made available to clients by installing them in the appropriate infrastructure, e.g., a database of purchase-order forms on a vendor's Web site. Users can retrieve and interact with the F-SSDOs through applications that understand the document representation language of the F-SSDO. User interaction may result in changes to the F-SSDO when, for example, the user enters information into input fields or alters the content of existing fields. When a user is finished interacting with an F-SSDO, the resulting document is a Processed SSDO (P-SSDO), as illustrated at 46.

2.3 Signature Generation

The user next indicates a desire to electronically sign the P-SSDO. This event causes the embedded signature processing program that manages the signature generation process to be executed. The signature program first collects and encodes the elements of the P-SSDO into a data structure. The data structure includes the elements of the P-SSDO in a predefined sequence, so that it can be recreated in the proper order later for signature verification purposes. The data structure is therefore referred to as the canonical representation of the document to be signed. If the P-SSDO contains user input fields, the data structure must include both the static application-specific document elements and the dynamic user-entered document elements, so that the signature binds the user-entered elements to the context of the document.

The embedded signature program decomposes the data structure representing the P-SSDO into a linear sequence of bits, as required by electronic signature algorithms, and retrieves the user's private signature key. The bit sequence and signature key are then passed to an appropriate signature algorithm, again, such as the DSS algorithm referred to above, which generates and returns an electronic signature. The signature algorithm may be an integral part of the signature processing program embedded in the P-SSDO, or it may be part of a separate cryptographic service provider module that the signature processing program accesses through a defined interface. The resulting electronic signature represents the state of the P-SSDO and the identity of the user responsible for creating the P-SSDO. A signed P-SSDO is referred to as an S-SSDO, as illustrated at 48.

The electronic signature is stored along with the S-SSDO for subsequent verification. The mechanism for maintaining an association between the S-SSDO and signature is application-specific: the signature may be stored as a physical part of the S-SSDO, or it may be stored separately and associated with the S-SSDO through an indexing scheme. In the event multiple signatures are required to authenticate a document, or (for example) authorize a contract, the S-SSDO may accordingly be signed sequentially by multiple users, in which case all of the signatures and the sequence in which they were generated are maintained. The S-SSDO is then transmitted to the intended recipient.

2.4 Signature Verification

It is important to achieving the objects of the invention as listed above that any party with access to a given S-SSDO, associated signature data, and the signer's public keying material can check the validity of the signature on that S-SSDO. To do this, the verifier runs an application program that retrieves and displays this information, and indicates a desire to verify the signature. This event executes the signature verification program embedded in the S-SSDO. The verification routine recreates the data structure, that is, the canonical representation of the document object at the time it was signed, and decomposes it into a bit sequence as before. The bit sequence, signature data, and signer's public key material are then used to verify the origin and structural integrity of the P-SSDO. Although the verification process may not produce changes in the structure of the P-SSDO, any document object upon which the associated signature has been verified at least once is referred to as a Verified SSDO (V-SSDO), as illustrated at 50. Signature verification may be performed on a P-SSDO an indefinite number of times.

2.5 Example: Purchase Order Processing

The following describes a prototype purchase request form submission system using SSDO technology according to the invention, using public key cryptography for signature processes, and presuming the existence of a supporting public key infrastructure. This prototype, known as SS-DHTML (Self-Signing Dynamic HTML), provides a concrete implementation and proof-of-concept for SSDO in a real-world application.

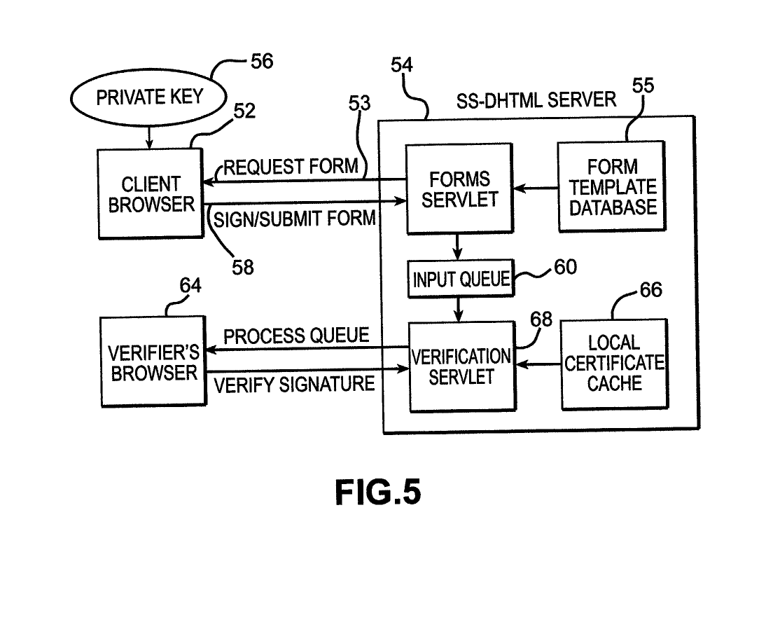

A general description of the public key infrastructure technology required to support certificate-based signature generation and verification can be found in NIST Special Publication 800-15, “Minimum Interoperability Specification for PKI Components (MISPC), Version 1”, the National Institute of Standards and Technology, January 1998. Numerous public key infrastructures based on MISPC and other models are currently in use, for example the PTO's Certificate Authority. The SS-DHTML prototype described herein supports user registration of cryptographic keys, signing/submission of electronic purchase request forms, and subsequent verification of electronic signatures attached to purchase requests, as described in detail in the following. Source code for the SS-DHTML SSDO according to the invention is provided in Appendix A. FIG. 5 summarizes the architecture of the SS-DHTML prototype code.

2.6 Registration

The existing public key scheme described above requires that a public/private key pair be generated for each user during the initial registration process. The private key is encrypted under a password known only to the user, and stored in encrypted form on a floppy disk supplied to the user, e.g., as illustrated at 56 in FIG. 5. The corresponding public key, along with other identifying information about the user, is assembled into a Certificate Signing Request (CSR) and sent to a Certificate Authority (CA). In response, the CA creates a public key certificate for the user, signs this certificate with the private key of the CA, and stores the signed certificate in a publicly accessible certificate database. The CA signature thus validates the link between the user's identity and the user's private key.

2.7 Filling Out a Purchase Request

In the example, a purchase request form, or template, is stored as an HTML file on the SS-DHTML web server, as illustrated at 54 in FIG. 5. This HTML file is equivalent to an F-SSDO, since it contains a signature processing program. In addition, the HTML file contains the textual elements associated with a purchase request, such as prompts for the requester's name, part numbers, quantities, line item descriptions, etc.

In the case where an individual seeks to purchase goods, the F-SSDO would typically be stored on the vendor's Website. In another model, pertinent for example to the internal processes of a large organization wherein a number of individuals must all sign a document before it is effectuated, the F-SSDOs might be stored in an internal website.

In the individual user example, when a user wishes to fill out a purchase request, he or she connects to the SS-DHML server using a standard Web browser, as illustrated at 52. The vendor's server responds at 53 by transmitting a copy of the purchase request HTML file, that is, the F-SSDO, accordingly including the signature processing algorithm, from a Form Template Database 55; the form is then displayed by the user's browser. The user fills out the form, and, for example, clicks on a button labeled “SIGN/SUBMIT”. This event executes the signature processing program, which in this example was provided to the user's computer as part of the form; the signature processing program retrieves the user's signature key from the floppy disk 56, prompts the user for the password, and uses it to decrypt the signature key.

The signature program assembles the text of the host HTML document into a data structure, converts this to a canonical bit sequence, and passes the signature key and bit sequence to the signature algorithm. The output of the signature algorithm is inserted into a hidden field in the host document, and the user-entered text and signature are returned to the vendor's SS-DHTML web server at 58 using the standard Hypertext Transfer Protocol (http) post method. At step 60, the server puts the purchase request data into an input queue file, for subsequent processing by verification entities, and processing of the order itself.

2.8 Verifying a Signature on a Purchase Request

When a verifier, in the example perhaps a person charged with processing orders, wishes to browse the SS-DHTML web server's input queue of pending purchase request documents, the server 54 sends a list of the documents in the input queue 60 to the verifier's browser, as indicated at 64. The verifier can select one or more documents to verify. Selection of a particular document prompts the server to retrieve the public key certificate for the user who signed that document from the CA's certificate database, or, if it has previously been downloaded, from a local cache 66. The user's public key certificate is sent to the verifier along with the document to be verified. The verifier's browser 64 presents the purchase request for review, and causes the validity of the signature on the document to be checked by clicking on a VERIFY button.

Clicking on the VERIFY button executes the signature processing program within the document. More specifically, the verifier “servlet” 68 forming part of the signature program verifies the authenticity of the user's public key certificate, by obtaining the public key of the CA that signed the user's certificate and verifying the CA's signature on the certificate, as indicated above, and extracts the user's public key from the CA's certificate database, or from local cache 66. The host document is converted to a data structure and then to a canonical bit sequence, which is passed to a signature verification algorithm along with the user's public key. If the results of the signature verification indicate that the signature is valid, then the verifier knows that the document was created by the user associated with the public key. The verifier also knows that the document was not altered after it was signed, since even a single-bit change in the binary representation of the document would cause the signature verification process to fail.

Provided below and incorporated herein by this reference is Appendix A, providing a complete disclosure of executable program code for implementing this aspect of the invention, namely, code titled “Representation of an SS-DHTML Document Object”, which defines self-signing electronic document objects suitable for processing using the HTML language, and “Sample HTML Source [Code] for an SS-HTML Document Object”, which provides the document objects having the verification algorithm embedded therein. As noted above, the invention is not limited to this implementation, and could be implemented using different document representation languages, such as that known as “XML”, or using “macros” as provided within another application program, such as Microsoft Word.

3. Self-Encrypting Document Processing

3.1 Introduction

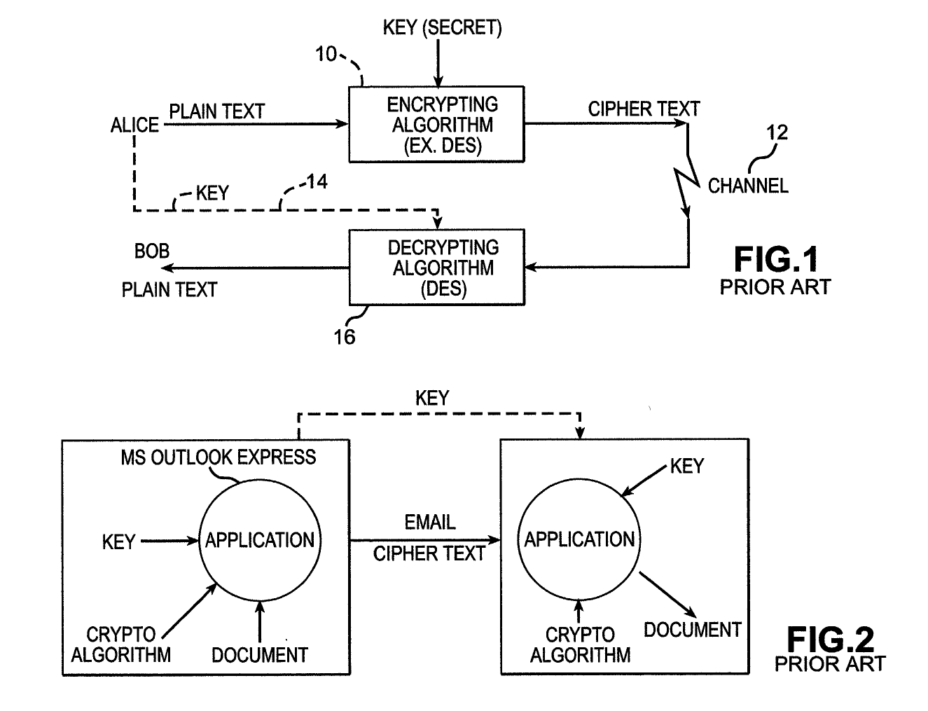

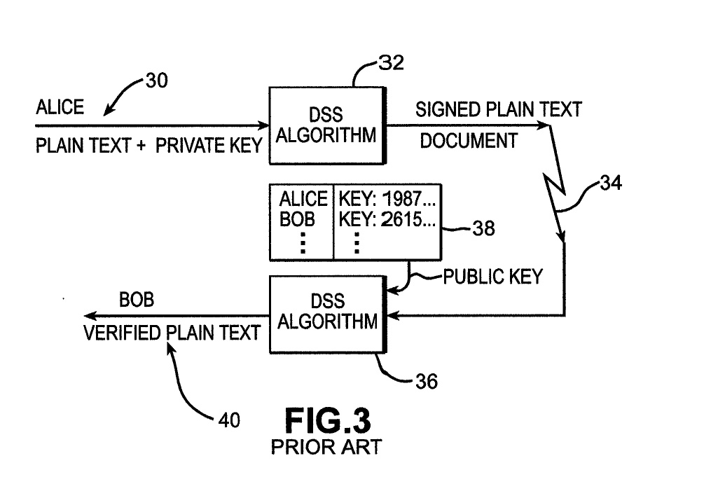

As mentioned above, and as will be apparent, confidentiality is vital to many electronic transactions. Specifically, it is often desirable to protect the contents of electronic documents during storage and transmission, so that only the document's originator and the intended recipients can view the contents of the document. Known cryptographic techniques are often used to ensure the confidentiality of electronic data. Using these techniques, the creator of an electronic document can encrypt the plaintext content of the document, transforming it into illegible ciphertext. Only parties who possess the correct cryptographic key can decrypt the document, transforming the ciphertext back into plaintext. See FIGS. 1 and 2, and the discussion thereof above. As also discussed above, traditional methods for encrypting and decrypting require a high degree of coordination between the application programs that process the electronic documents, because each application program needs to possess precisely the identical capability for encryption and decryption of documents.

According to the present invention, a method is provided for creating Self-Encrypting/decrypting Electronic Document Objects (SEDOs) that contain an embedded Cipher Management Program (CMP). The encryption and decryption processes are encapsulated within the SEDOs according to the invention, and otherwise require only the standard capabilities of document representation languages that support dynamic content. This method is a vast improvement over traditional document encryption systems, because SEDOs can be processed by any application that understands the standard document representation language of an SEDO, e.g., any functional Web browser.

More specifically, secure electronic commerce and communication often require the confidential exchange of electronic documents between parties. In some cases these electronic documents are stored for a period of time before they are accessed by the intended recipients. During storage and transmission, it is possible that unauthorized parties will attempt to view the contents of these documents. A variety of cryptographic techniques can be employed to prevent unauthorized disclosure of information. Cryptographic algorithms suitable for providing confidentiality protection of electronic data are described in publications such as FIPS PUB 46-2, “Data Encryption Standard (DES)”, The National Institute of Standards and Technology, December 1993. The originator of an electronic document can encrypt that document using a cryptographic key known only to the originator and the intended recipients. Only parties with the correct cryptographic key can decrypt the document and view its contents in plaintext form. Unauthorized parties are faced with the difficult task of stealing or guessing the cryptographic key needed to decrypt the document, an extremely difficult task in a well-designed cryptosystem.

As discussed above, electronic documents are often encoded in Web-compatible formats such as HyperText Markup Language (HTML) (see REC-HTML40-19980424, “HTML 4.0 Specification”, W3C Recommendation, April 1998.). These documents are translated and presented in human-readable form by Web browsers and other document-oriented applications. Current Web encryption technology relies primarily on the Secure Sockets Layer (“SSL”) protocol (see A. Freier, P. Karlton, and P. Kocher, “The SSL Protocol Version 3.0”, http://home.netscape.com/eng/ssl3/ssl-toc.html, March 1996) to provide confidential exchange of information between client systems and web servers. Although SSL establishes an encrypted client-server channel, it does not provide confidentiality for electronic documents during storage or transmission outside the context of the client-server exchange. SSL is essentially a session-based protocol, and the confidentiality it provides through cryptographic mechanisms is only available for the duration of a client-server session.

In addition to SSL, other methods must be used to ensure confidentiality throughout the lifecycle of an electronic document. To accomplish this, traditional methods treat electronic documents as static data to be encrypted or decrypted by executable programs external to the document. This requires a high degree of coordination between all the systems involved in processing the document, since the same cryptographic algorithms and document format information must be available to all systems involved in processing the document. Document objects are often decrypted, processed in some way, encrypted again using a different cryptographic algorithm and/or different cryptographic key, and passed to subsequent stages of the document lifecycle where the process is repeated.

3.2 The Self-Encrypting Document Object Model

As noted above, many document representation languages allow developers to include executable content (programs) within electronic documents. A prime example is Dynamic HTML, which supports scripting languages such as JavaScript and Java applets. The present invention comprises a method that takes advantage of this feature to create Self-Encrypting Document Objects (SEDOs). As above, these document objects are called “self-encrypting” because they have the ability to encrypt and decrypt static content within the host document object, when asked to do so by human users who possess the appropriate cryptographic keying material. An important aspect of the invention is that the algorithms required to manage the cryptographic operations relevant to a host document are packaged with, rather than external to, SEDOs; this allows unprecedented flexibility of use of the known cryptographic algorithms.

SEDOs according to the invention contain an embedded Cipher Management Program (CMP) for managing the encrypting and decrypting of document content, that is, for organizing the document object into a canonical form suitable for processing by the encryption algorithm, and performing the encryption itself. Since the cipher management operations are embedded in document objects, these operations are independent of the applications that process document objects. Each time a document object is instantiated, a copy of the CMP becomes part of that object. This facility permits developers to create application-independent SEDOs by using standard templates that include a CMP, rather than repeatedly implementing standalone program routines for each document processing application.

Embedding the CMP in an SEDO is an important step in the method of creating self-encrypting documents according to the invention, as the CMP manages encryption and decryption of the host document object. The CMP is activated by events that occur within the context of the host document object, e.g. a user clicking on a button that is an element of the document. A CMP may be physically embedded within the host document, or may be an external program file that is executed through a link within the document. Similarly, the encryption algorithm itself may be embedded within the SEDO, essentially as part of an embedded CMP, or may by linked to the SEDO by a link in the CMP. Hence both the CMP and the algorithms may be embedded into or linked to the program.

The principal functions of the CMP are thus as follows:

At a transmitting computer:

Collecting the elements of the host document into a data structure that represents the canonical form of the document at the time of encryption/decryption;

Reducing the canonical data structure into a bit sequence suitable for processing by a cryptographic algorithm;

Obtaining cryptographic key material in a secure manner, and processing the bit sequence using the cryptographic algorithm and key material, or passing the data to be encrypted/decrypted to a secure cryptographic module for such processing;

Retrieving the output of the cryptographic algorithm; and

Transmitting the encrypted message; and

At a receiving computer:

Examining the message, to determine whether it contains either or both of the CMP and decryption algorithm;

Downloading either or both of the CMP and decryption algorithm as necessary;

obtaining the sender's key material, from another communication channel;

Decrypting the message using the key material and received or downloaded decryption algorithm;

Notifying human users of the results of encryption/decryption processes; and

Passing the plaintext or ciphertext data to host applications.

3.3 Life Cycle of Self-Encrypting Document Objects

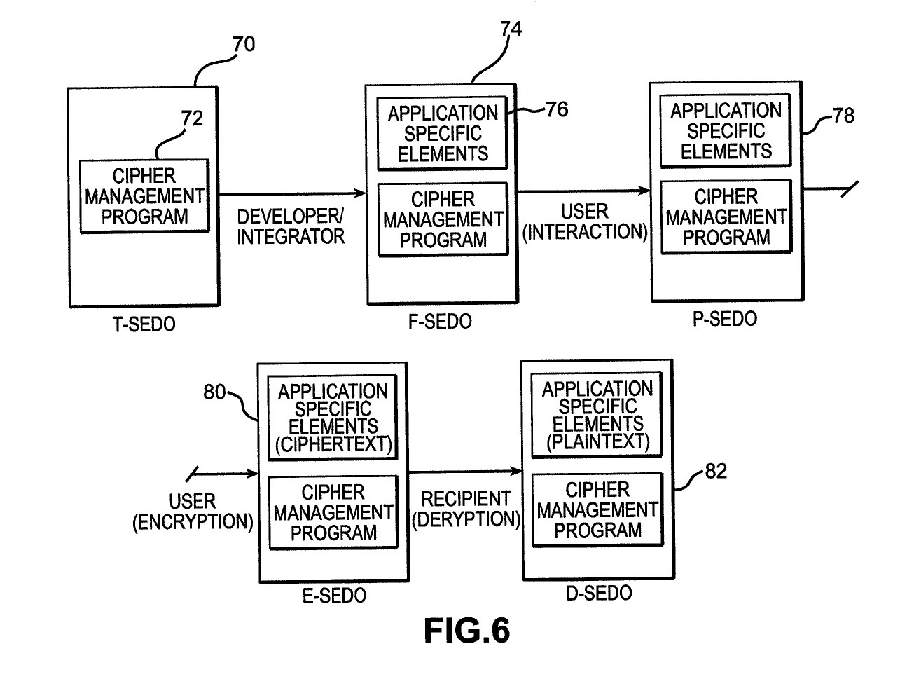

This section of this application describes the generic life cycle of SEDOs according to the invention, independent of the document representation language used to encode the host document. The only language-specific requirement for implementing SEDOs is that the document representation language must support embedded dynamic elements, e.g., the ability to execute programs based on events that occur within the context of the document object. The SEDO lifecycle is summarized by FIG. 6.

3.4 SEDO Fabrication

Referring now to FIG. 6, SEDOs start out as Template SEDOs (T-SEDOs), which, as illustrated at 70, contain an embedded Cipher Management Program (CMP) 72. The CMP is generic in the sense that it will work with any application program that understands the standard document representation language of the T-SEDO, and therefore does not need to be modified for different applications. A typical CMP implements the DES data encryption algorithm discussed above. The CMP in a T-SEDO supports the functions listed above. As illustrated at 74, it is anticipated that developers will customize the T-SEDOs by adding application-specific elements 76 to these T-SEDOs, such as labels and text input fields. After a T-SEDO has been customized by adding application-specific elements, it is referred to as a Fabricated SEDO (F-SEDO). An F-SEDO is always specific to a particular application set, since it contains application-specific elements 76 in addition to the application-independent CMP 72.

3.5 User Processing

F-SEDOs are then made available to clients by installing them in the appropriate infrastructure. Users can retrieve and interact with the F-SEDOs through applications that understand the document representation language of the F-SEDO. User interaction may result in changes to the F-SEDO when, for example, the user enters information into input fields or alters the content of existing fields. When a user is finished interacting with an F-SEDO, the resulting document is a Processed SEDO (P-SEDO), illustrated at 78.

3.6 Encryption

When the user indicates a desire to encrypt the P-SEDO, to protect the confidentiality of information contained in the document, the embedded CMP 72 that manages the encryption process is executed. In so doing, the CMP first collects and encodes the elements of the P-SEDO into a data structure. The data structure is therefore the canonical representation of the document to be encrypted. If the P-SEDO contains user input fields (i.e. if the document to be encrypted includes user-completed fields, as in the case of a purchase order or like form), the CMP may be configured to include both static data elements and the dynamic user-entered document elements.

The embedded CMP then decomposes the data structure representing the P-SEDO into a linear sequence of bits, as required by cryptographic algorithms, and retrieves the user's secret encryption key. The bit sequence and encryption key are then passed to an appropriate encryption algorithm, which generates and returns an encrypted (ciphertext) form of the document. The encryption algorithm may be an integral part of the CMP embedded in the P-SEDO, or it may be part of a separate cryptographic service provider module that the CMP accesses through a defined interface. An encrypted P-SEDO is referred to as an E-SEDO, and is illustrated at 80.

The encrypted (ciphertext) component of an E-SEDO is stored and/or transmitted, along with the remainder of the E-SEDO, for subsequent decryption. The mechanism for maintaining an association between the E-SEDO and ciphertext content is application-specific: the encrypted data may be stored as a physical part of the E-SEDO, or it may be stored separately and associated with the E-SEDO through an indexing scheme. An E-SEDO may also be encrypted sequentially by multiple users, possibly with different cryptographic algorithms and/or cryptographic keys. In this case all of the encrypted versions of the document and the sequence in which they were generated must be maintained.

3.7 Decryption

Any party with access to a given E-SEDO and the proper decryption key can decrypt the E-SEDO. To do this, the authorized party runs an application program that retrieves and displays the E-SEDO and indicates a desire to decrypt it in order to view the plaintext of the original document. This event executes the CMP embedded in the E-SEDO. The CMP then retrieves the ciphertext component of the E-SEDO, obtains the symmetric key needed to decrypt the ciphertext component using a secure protocol, and decrypts the ciphertext to produce plaintext. This transformation produces a Decrypted SEDO (D-SEDO), illustrated at 82, containing a plaintext representation of the original P-SEDO.

Those of skill in the art will recognize the analogy between the SEDO method described immediately above and the SSDO method described in detail earlier, and will have no difficulty implementing the SEDO method based on the detailed disclosure of the SSDO method presented, in particular the actual code provided by Appendix A.

It will also be recognized by those of skill in the art that while a specific example of the invention has been provided, including a specific implementation employing the HTML language, other embodiments of the invention are within the skill of the art. In particular, the teachings of the invention are applicable to any computer language permitting a document object including both text and executable code to be communicated, as this condition allows for embedding the encryption/decryption or message verification algorithms in the document object. Furthermore, while the invention has been described in an embodiment involving a symmetrical, private encryption scheme for self-encryption, and an asymmmetrical, public-key scheme for signature verification, the invention is not to be thus limited.

Therefore, the invention is not limited by the above exemplary disclosure, but only by the appended claims.

What is claimed is:

1. A method for communicating a document from a sender to a recipient, wherein the recipient is enabled to verify the contents of the document, comprising the steps of:
defining a format for document transmission in a document representation language suitable for processing documents including both text and operable code, said format including either (a) an algorithm for encoding the document according to a private key known only to the sender, or (b) a link to a site providing an algorithm for so processing the document;
at a transmitting location:
employing said format to generate an encoded message, said message including a version of said document that is encoded according to the sender's private key, includes an identification of the sender, and also includes one of (a) an algorithm for decoding the document according to a private key known only to the sender, or (b) a link to a site providing an algorithm for so decoding the document; and
transmitting said document; and
at a receiving location:
receiving the encoded message;
employing the identity of the sender to obtain a public key corresponding to said private key and said decoding algorithm; and
employing said public key and the decoding algorithm to decode the document to verify its contents.

2. The method of claim 1, wherein said template includes definition of fields for user insertion of specific information, and said encoded message includes definition of said fields and information placed therein by a user.

3. The method of claim 1, wherein said encoding and decoding algorithms collectively perform the following steps:
collecting the elements of the host document into a data structure that represents the canonical form of the document at the time of signature;
reducing the canonical data structure into a bit sequence suitable for processing by an electronic signature algorithm;
obtaining a cryptographic key;
passing the bit sequence and key material to an electronic signature algorithm, which then provides a suitably encoded message;
retrieving the output of the signature algorithm;
notifying human users of the results of signature verification processes; and
passing the signature and signed data to host applications.

4. A method for employing self-signing document objects (SSDOs) for communication of messages capable of verification by a recipient, comprising the steps of:
defining a Template SSDO (T-SSDO) containing an embedded electronic signature processing and verification program, and which is capable of accepting application-specific additional elements;
adding application-specific elements to the T-SSDO, to create a Fabricated SSDO (F-SSDO;
making the F-SSDO available to a user, such that the user can retrieve and interact with the F-SSDO, resulting in a Processed SSDO (P-SSDO);
permitting the user to electronically sign the P-SSDO, causing execution of the embedded signature processing program, in response to which the signature processing program: (1) collects and encodes the elements of the P-SSDO into a data structure including the elements of the P-SSDO in a predefined sequence, (2) decomposes the data structure representing the P-SSDO into a linear sequence of bits, (3) retrieves the user's private signature key, and (4) generates and returns an electronic signature, referred to as an S-SSDO, responsive to said linear series of bits, said private key, and a predetermined algorithm;
storing the S-SSDO for subsequent verification;
transmitting the S-SSDO to the intended recipient; and
executing the signature verification program embedded in the S-SSDO, by: (1) recreating the data structure, (2) decomposing the data structure to generate a bit sequence, (3) retrieving the signer's public key information; and (4) employing the bit sequence, signature data, and signer's public key material to verify the origin and structural integrity of the P-SSDO.

5. A method for communicating an encrypted message from a sender to a recipient, comprising the steps of:
employing a secret key unique to the sender to encrypt the message, using a known encryption algorithm having a corresponding known decryption algorithm;
transmitting the encoded message to the recipient in a language permitting executable software instructions to be embedded in a message also including data, and employing a message format including the decryption algorithm, or a link to a site providing the decryption algorithm, as executable instructions, and the encoded message as data;
separately transmitting the secret key to the recipient; and
employing the decryption algorithm embedded in the message or the link to a site providing the algorithm and the secret key to decrypt the message.

6. The method of claim 5, wherein said message format is defined by provision of a template wherein the algorithm is provided as part of a cipher management program, said template accepting application-specific elements such as the message to be transmitted.

7. The method of claim 6, wherein said cipher management program performs the following functions:
Collects the elements of the message to be communicated into a data structure that represents the canonical form of the document;
Reduces the canonical data structure into a bit sequence suitable for processing by a cryptographic algorithm;
Obtains the secret key;
Passes the bit sequence and key material to a cryptographic algorithm;
Retrieves the output of the cryptographic algorithm;
Notifies a user of the results of encryption/decryption processes; and
Passes the plaintext or ciphertext data to host applications.

8. A method for employing self-encrypting document objects (SEDOs) for communication of encrypted messages capable of decryption by a recipient, comprising the steps of:
defining a Template SEDO (T-SEDO) containing an embedded cipher management program, and which is capable of accepting application-specific additional elements;
adding application-specific elements to the T-SEDO, to create a Fabricated SSDO (F-SEDO;
making the F-SEDO available to a user, such that the user can retrieve and interact with the F-SEDO, resulting in a Processed SEDO (P-SEDO);
permitting the user to indicate a desire to encrypt the P-SEDO, causing execution of the embedded cipher management program, in response to which the cipher management program: (1) collects and encodes the elements of the P-SEDO into a data structure including the elements of the P-SEDO in a predefined sequence, (2) decomposes the data structure representing the P-SEDO into a linear sequence of bits, (3) retrieves the user's secret encryption key, and (4) generates and returns an encrypted form of the P-SEDO, referred to as an E-SEDO, responsive to said linear series of bits, said secret encryption key, and a predetermined algorithm;
storing the E-SEDO for subsequent verification;
transmitting the E-SSDO to the intended recipient; and
executing the decryption program embedded in the E-SEDO, by: (1) recreating the data structure, (2) decomposing the data structure to generate a bit sequence, (3) retrieving the signer's secret encryption key information; and (4) employing the bit sequence and signer's secret encryption key material to decrypt the E-SEDO.
